(19) United States
(12) Patent Application Publication
(10) Pub. No.: US 2009/0285236 A1
(43) Pub. Date: Nov. 19, 2009

(54) START CODE DETECTING APPARATUS

(75) Inventor: Kumiko MORITA, Yokohama-Shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/404,725

(22) Filed: Mar. 16, 2009

(30) Foreign Application Priority Data
May 14, 2008 (JP) 2008-127491

(51) Int. Cl. H04L 29/02

(52) U.S. Cl. 370/474

(57) ABSTRACT

A start code detecting apparatus comprises a data inputting unit which inputs PES data, a start code searching unit which searches for a code of a predetermined byte included in the PES data inputted by the data inputting unit, a separated start code estimating unit which refers to a stream located next to a code of a predetermined byte searched by the start code searching unit and estimates whether there is a separated ES start code or not based on the reference result, and a data outputting unit which outputs predetermined data. The start code searching unit generates location data which represents a location of the PES start code or the ES start code based on the searching result and the estimation result of the separated start code estimating unit. The data outputting unit outputs the location data generated by the start code searching unit.

### CROSS-REFERENCE TO RELATED APPLICATIONS

This application is based upon and claims the benefit of priority from the prior Japanese Patent Application No. 2008-127491 filed on May 14, 2008; the entire contents of which are incorporated herein by reference.

### BACKGROUND OF THE INVENTION

1. Field of the Invention

The present invention relates to a start code detecting apparatus, and more particularly, to a start code detecting apparatus which detects a start code included in a bit stream.

2. Related Art

Generally, in case of searching for a certain pattern from target data, pattern matching with respect to a search target pattern is performed. In pattern matching, search target data is read from a memory and is compared with a search target pattern, and if matched, read location information, when they are matched, is written in a memory.

For example, in a start code detecting apparatus installed in a decoder of video data or audio data, if a packetized elementary stream (PES) start code “0x000001” and an elementary stream (ES) start code “0x000001” are search target pattern, a PES start code detecting apparatus which detects a PES start code and an ES start code detecting apparatus which detects an ES start code are necessary (see Japanese Patent Application Laid-Open No. 2004-266370).

In this case, a PES header analyzing unit which analyzes a PES header is disposed between the PES start code detecting apparatus and the ES start code detecting apparatus. After the PES start code is detected by the PES start code detecting apparatus, data (that is, ES data) excluding the PES header is extracted by the PES header analyzing unit, and the ES start code is detected from the ES data by the ES start code detecting apparatus. The PES start code detecting apparatus performs pattern matching with respect to a pattern including a stream ID located next to the PES start code “0x000001”, and the ES start code detecting apparatus performs pattern matching with respect to only the ES start code “0x000001”.

In this case, however, since pattern matching with respect to the ES start code after pattern matching with respect to the PES start code is performed, twice pattern matching (that is, searching) is necessary in order to detect the PES start code and the ES start code. As a result, a processing time of the start code detecting apparatus is prolonged. Particularly, since video data and audio data have a large amount of data, influence of a phenomenon that the data processing speed is decreased due to twice searching is large.

### SUMMARY OF THE INVENTION

According to a first aspect of the present invention, there is provided a start code detecting apparatus, comprises

a data inputting unit which inputs packetized elementary stream (PES) data;

a start code searching unit which searches for a code of a predetermined byte included in the PES data inputted by the data inputting unit;

a separated start code estimating unit which refers to a stream identification (ID) located next to a code of a predetermined byte searched by the start code searching unit and estimates whether there is a separated ES (Elementary Stream) start code or not based on the reference result; and

a data outputting unit which outputs predetermined data,

wherein the start code searching unit generates location data which represents a location of the PES start code or the ES start code based on the searching result and the estimation result of the separated start code estimating unit, and

the data outputting unit outputs the location data generated by the start code searching unit.

According to a second aspect of the present invention, there is provided a start code detecting method, comprises

inputting packetized elementary stream (PES) data;

searching for a code of a predetermined byte included in the PES data;

refering to a stream identification (ID) located next to a code of the predetermined byte,

estimating whether there is a separated ES (Elementary Stream) start code or not based on the reference result;

generating location data which represents a location of the PES start code or the ES start code; and

outputting the location data.

According to a third aspect of the present invention, there is provided a computer readable medium storing start code detecting program, the program comprises

a data inputting instruction which inputs packetized elementary stream (PES) data;

a start code searching instruction which searches for a code of a predetermined byte included in the PES data inputted by the data inputting instruction;

a separated start code estimating instruction which refers to a stream identification (ID) located next to a code of a predetermined byte searched by the start code searching instruction and estimates whether there is a separated ES start code or not based on the reference result; and

a data outputting instruction which outputs predetermined data,

wherein the start code searching instruction generates location data which represents a location of the PES start code or the ES start code based on the searching result and the estimation result of the separated start code estimating instruction, and

the data outputting instruction outputs the location data generated by the start code searching instruction.

### BRIEF DESCRIPTION OF THE DRAWINGS

FIG. 1 is a block diagram illustrating a system configuration which includes a start code detecting apparatus 100 according to the first embodiment of the present invention.

FIG. 2 is a block diagram illustrating a configuration of the start code detecting apparatus 100 according to the first embodiment of the present invention.

FIG. 3 is a flowchart illustrating a start code detecting process according to the first embodiment of the present invention.

FIG. 4 is a flowchart illustrating a start code searching process (S301 of FIG. 3) according to the first embodiment of the present invention.

FIG. 5 is a flowchart illustrating a separated ES start code estimating process (S306) of FIG. 3.

FIG. 6 is a block diagram illustrating a configuration of a start code detecting apparatus 200 according to the second embodiment of the present invention.

FIG. 7 is a flowchart illustrating a start code detecting process according to the second embodiment of the present invention.

FIG. 8 is a schematic diagram illustrating a structure of a buffer 205 according to the first modification of the second embodiment of the present invention.

FIG. 9 is a block diagram illustrating a configuration of a start code detecting apparatus 300 according to the third embodiment of the present invention.

FIG. 10 is a flowchart illustrating a start code searching process according to the third embodiment of the present invention.

FIG. 11 is schematic diagram illustrating a sate of the separated ES start code according to the embodiments of the present invention.

FIG. 12 is a flowchart illustrating a separated start code estimating process according to the third embodiment of the present invention.

### DETAILED DESCRIPTION OF THE INVENTION

Hereinafter, embodiments of the present invention will be described with reference to the accompanying drawings. The embodiments of the present invention described below are illustrative and not restrictive.

### First Embodiment

First, a first embodiment of the present invention will be described. The first embodiment of the present invention deals with an example that a start code of PES data read from a memory is detected.

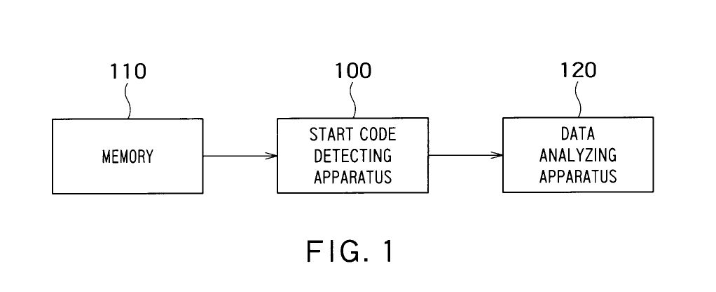

FIG. 1 is a block diagram illustrating a system configuration which includes a start code detecting apparatus 100 according to the first embodiment of the present invention.

The start code detecting apparatus 100 is connected to a memory 110 and a data analyzing apparatus 120. The start code detecting apparatus 100 outputs location data (address) which represents a location of a header (hereinafter, “PES header”) of PES data or a header (hereinafter, “ES header”) of ES data which is stored in the memory 110 to the data analyzing apparatus 120.

The memory 110 stores data which is used in processing of the start code detecting apparatus 100. For example, data stored in the memory 110 includes PES data or ES data of a video signal or an audio signal.

The data analyzing apparatus 120 analyzes PES data or ES data based on the location data outputted from the start code detecting apparatus 100.

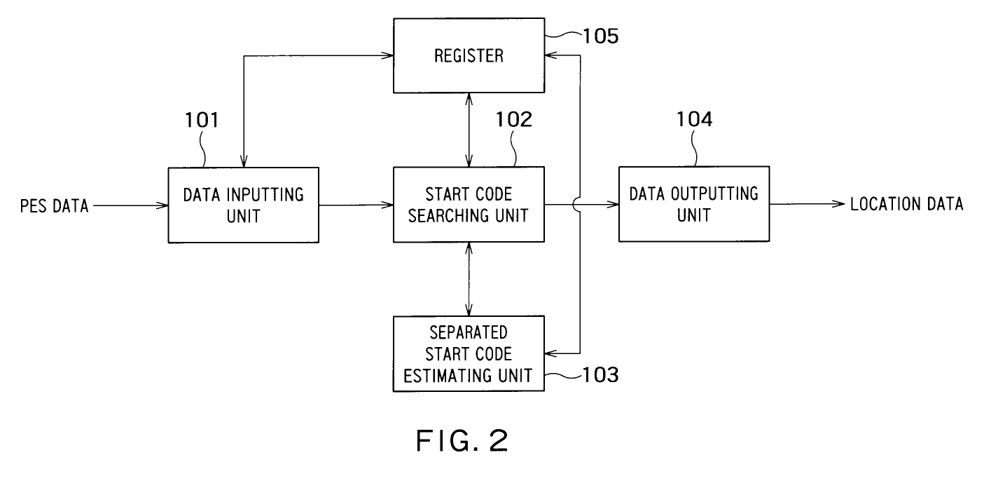

FIG. 2 is a block diagram illustrating a configuration of the start code detecting apparatus 100 according to the first embodiment of the present invention.

The start code detecting apparatus 100 includes a data inputting unit 101, a start code searching unit 102, a separated start code estimating unit 103, a data outputting unit 104, and a register 105.

The data inputting unit 101 reads PES data from the memory 110 and transmits the PES data to the start code searching unit 102.

The start code searching unit 102 searches for a code of a predetermined byte included in the PES data inputted from the data inputting unit 101. The start code searching unit 102 generates location data which represents a location of a PES start code or an ES start code based on the searching result and an estimation result of the separated start code estimating unit 103, and transmits the location data to the data outputting unit 104. The location data includes address information which represents a location of a start code and identification (ID) information which identifies the PES start code or the ES start code.

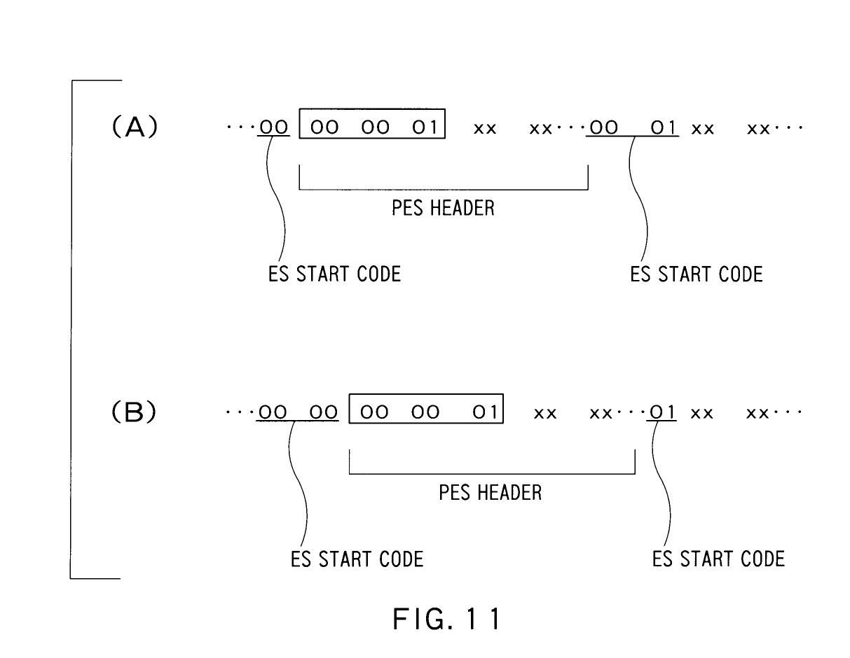

The separated start code estimating unit 103 refers to a stream ID located next to a start code searched by the start code searching unit 102, estimates whether there is a separated ES start code which is separated by the PES header or not based on the reference result (see FIG. 11), and transmits the estimation result to the start code searching unit 102. Also, the separated start code estimating unit 103 reads data stored in the register 105 by controlling a read location of the register 105.

The data outputting unit 104 outputs the location data received from the start code searching unit 102 to the data analyzing apparatus 120.

The register 105 stores a read address of the memory 110 accessed by the data inputting unit 101 when data is read from the memory 110.

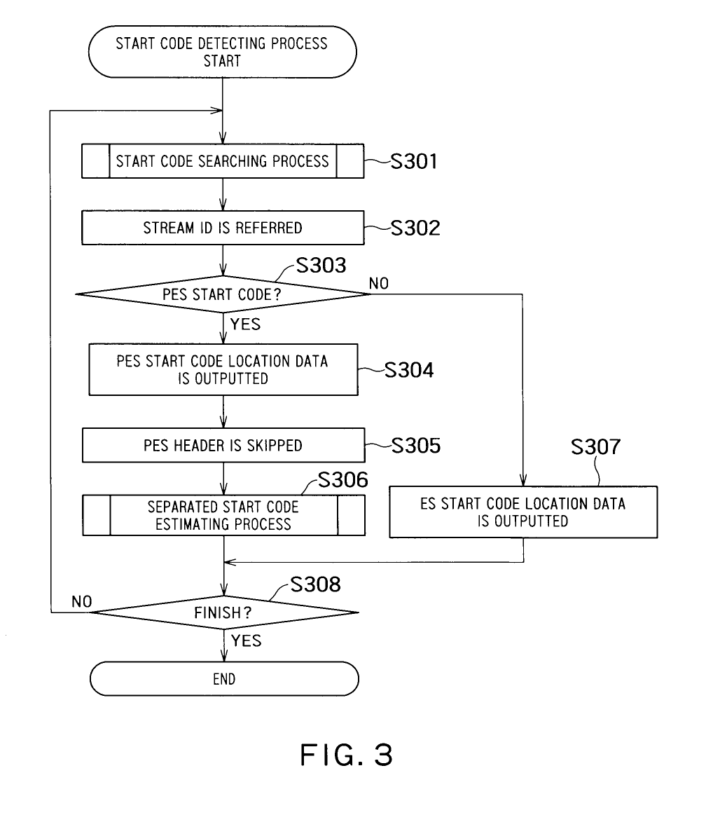

FIG. 3 is a flowchart illustrating a start code detecting process according to the first embodiment of the present invention.

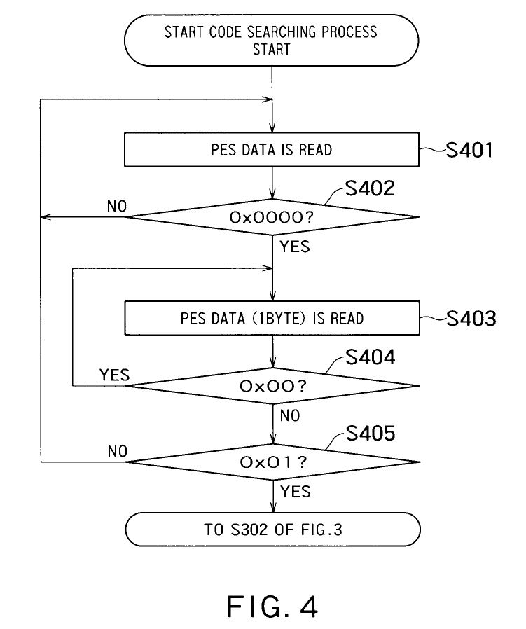

First, the start code searching unit 102 performs a start code searching process (FIG. 4) for searching for a code of a predetermined byte included in PES data inputted from the data inputting unit 101 (S301).

Next, the start code searching unit 102 reads a stream ID from the memory 110 and refers to the stream ID (S302). The stream ID is identification (ID) information which represents the stream content.

If the reference result (steam ID) of S302 represents the PES (is identical to a certain value of the PES start code) (S303-YES), the data outputting unit 104 outputs PES start code location data which represents a location of the PES start code (S304).

Next, the start code searching unit 102 skips the PES header having the predetermined header length among PES data stored in the memory 110 (S305).

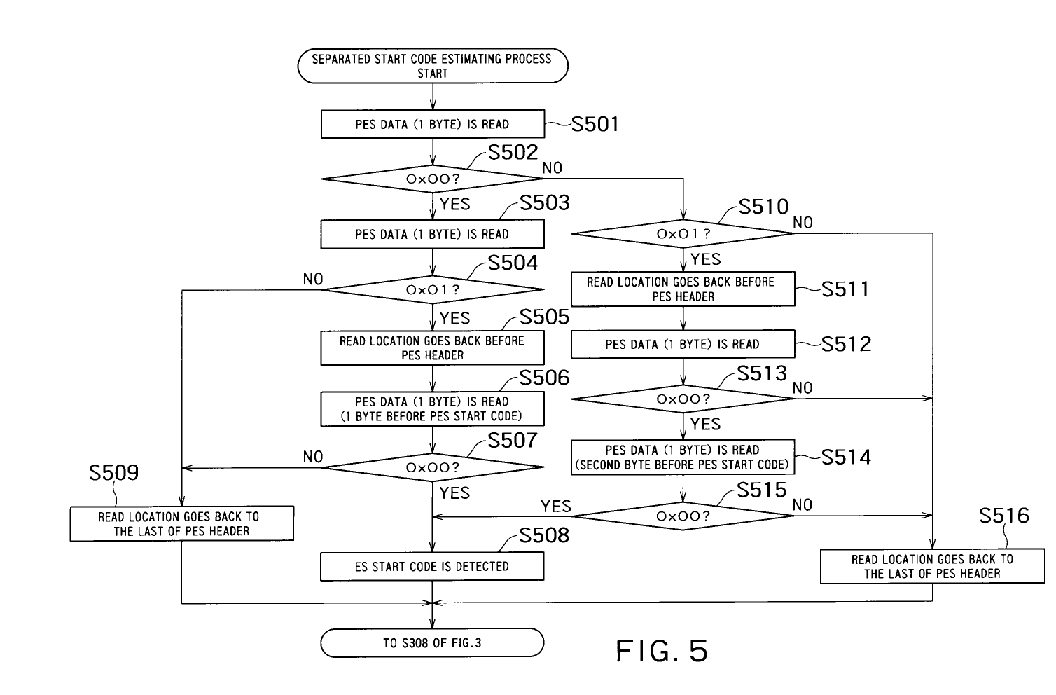

Next, the separated start code estimating unit 103 performs a separated start code estimating process (FIG. 5) for estimating whether there is a separated ES start code which is separated by the PES header or not based on the reference result (stream ID) (S306).

On the other hand, if the reference result (stream ID) of S302 represents the ES start code (is not identical to a certain value of the PES start code) (S303-NO), the data outputting unit 104 outputs ES start code location data which represents a location of the ES start code (S307).

S301 to S307 are repetitively performed until there is an instruction to finish the start code detecting process (S308-NO), and if there is an instruction to finish the start code detecting process (S308-YES), the start code detecting process according to the first embodiment of the present invention is finished.

FIG. 4 is a flowchart illustrating a start code searching process (S301 of FIG. 3) according to the first embodiment of the present invention.

First, PES data stored in the memory 110 is read one byte by one byte (S401). S401 is repetitively performed until a predetermined code (for example, “0x0000”) is searched (S402-NO).

If the PES data read in S401 is a predetermined code (S402-YES), PES data located next to the PES data read in S401 is read one byte (S403).

If the PES data read in S403 is a predetermined code (for example, “0x00”) (S404-YES), the procedure returns to S403.

However, if the PES data read in S403 is not a predetermined code (for example, “0x00” or “0x01”) (S404-NO, S405-NO), the procedure returns to S401.

On the other hand, if the PES data read in S403 is a predetermined code (for example, “0x01”) (S404-NO, S405-YES), the procedure proceeds to S302 of FIG. 3. S405-YES means that a predetermined code (“0x000001”) has been detected.

FIG. 5 is a flowchart illustrating a separated ES start code estimating process (S306) of FIG. 3.

First, PES data located next to a PES header is read one byte (S501).

If the PES data read in S501 is a predetermined code (for example, “0x00”) (S502-YES), PES data located next to the PES data read in S501 is read one byte (S503).

If the PES data read in S503 is a predetermined code (for example, “0x01”) (S504-YES), a read location goes back before a PES header (that is, one byte before a start code) (S505). S504-YES means that a predetermined code (“0x0001”) located next to the PES header has been detected. This means that the ES start code can be separated as shown in FIG. 11A.

Next, PES data located at one byte before a PES start code is read one byte (S506).

If the PES data read in S506 is a predetermined code (for example, “0x00”) (S507-YES), which is a part of the ES start code not detected, it is estimated that the ES start code is separated, and so the ES start code is detected (S508).

On the other hand, if the PES data read in S503 is not a predetermined code (for example, “0x01”) (S504-NO) or if the PES data read in S506 is not a predetermined code (for example, “0x00”) (S507-NO), a read location goes back to the last of the PES header (S509). S504-NO and S507-NO mean that the ES start code is not separated. Therefore, search of the start code is restarted from the data located next to the PES header.

On the other hand, if the PES data read in S501 is not a predetermined code (for example, “0x00”) (S502-NO) but a predetermined code (for example, “0x01”) (S510-YES), a read location goes back before a PES header (that is, one byte before a start code) (S511). S510-YES means that a predetermined code (“0x01”) located next to the PES header has been detected. This means that the ES start code is separated as shown FIG. 11B.

Next, the PES data is read one byte (S512).

If the PES data read in S512 is a predetermined code (for example, “0x00”) (S513-YES), PES data located at second byte before the PES start code is read one byte (S514).

If the PES data read in S512 is not a predetermined code (for example, “0x00”) (S513-NO) or if the PES data read in S514 is not a predetermined code (for example, “0x00”) (S515-NO), a read location goes back to the last of the PES header (S516).

On the other hand, if the PES start code read in S514 is a predetermined code (for example, “0x00”) (S515-YES), which is a part of the ES start code not detected, it is estimated that the ES start code is separated, and so the ES start code is detected (S508).

After S509, S508 or S516, the procedure proceeds to S308 of FIG. 3.

According to the first embodiment of the present invention, since the PES start code and the ES start code are searched by the start code searching unit 102 and the separated start code estimating unit 103, the number of searching times can be decreased, and thus a processing time of the start code detecting apparatus 100 can be decreased.

### Second Embodiment

Next, a second embodiment of the present invention will be described. The second embodiment of the present invention deals with an example that PES data read from a memory is stored in a buffer. The duplicated description with respect to the first embodiment of the present invention will not be repeated.

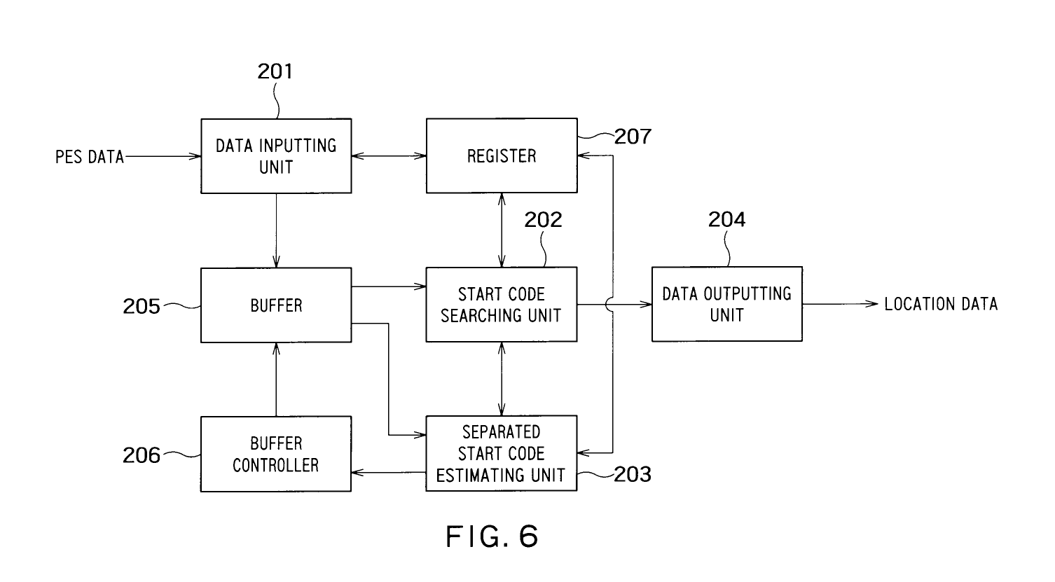

FIG. 6 is a block diagram illustrating a configuration of a start code detecting apparatus 200 according to the second embodiment of the present invention.

The start code detecting apparatus 200 includes a data inputting unit 201, a start code searching unit 202, a separated start code estimating unit 203, a data outputting unit 204, a buffer 205, a buffer controller 206, and a register 207.

The data inputting unit 201 reads PES data from the memory 110 and writes the PES data in the buffer 205.

The start code searching unit 202 searches for a code of a predetermined byte included in the PES data stored in the buffer 205. The start code searching unit 202 generates location data which represents a location of a PES start code or an ES start code based on the searching result and an estimation result of the separated start code estimating unit 203, and transmits the location data to the data outputting unit 204. The location data includes address information which represents a location of a start code and identification (ID) information which identifies the PES start code or the ES start code.

The separated start code estimating unit 203 refers to a stream ID located next to a start code searched by the start code searching unit 202, estimates whether there is a separated ES start code which is separated by the PES header or not based on the reference result, and transmits the estimation result to the start code searching unit 202. Also, the separated start code estimating unit 203 reads data stored in the register 207 by controlling a read location of the register 207.

The data outputting unit 204 outputs the location data received from the start code searching unit 202 to the data analyzing apparatus 120.

The buffer 205 stores the PES data written by the data inputting unit 201.

The buffer controller 206 controls writing and reading of data stored in the buffer 205.

The address register 207 stores a read address of the memory 110 accessed by the data inputting unit 201 when data is read from the memory 110.

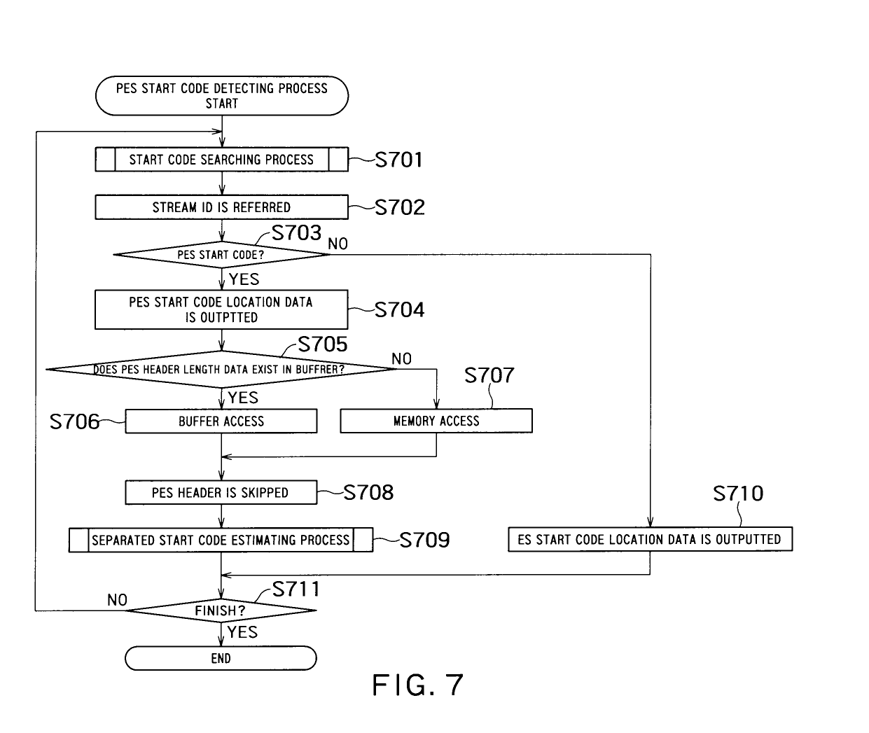

FIG. 7 is a flowchart illustrating a start code detecting process according to the second embodiment of the present invention.

First, the start code searching unit 202 performs a start code searching process (FIG. 4) for searching for a code of a predetermined byte included in PES data stored in the buffer 205 (S701).

Next, the start code searching unit 202 reads a stream ID from the buffer 205 and refers to the stream ID (S702).

If the reference result of S702 represents the PES start code (S703-YES), the data outputting unit 204 outputs PES start code location data which represents a location of the PES start code (S704).

If data (hereinafter, “PES header length data”), which represents the header length of a PES head, exists in the buffer 205 (S705-YES), buffer access is performed, and the PES header length data stored in the buffer 205 is referred (S706). On the other hand, if the PES header length data does not exist in the buffer 205(S705-NO), memory access is performed, and the PES header length data stored in the memory 110 is referred (S707).

Next, the PES header is skipped based on the PES header length data referred in S706 or S707 (S708).

Next, the separated start code estimating unit 203 performs a separated start code estimating process (FIG. 5) for estimating whether the code is the PES start code, the ES start code or the separated start code based on the reference result (S709).

On the other hand, if the reference result of S702 represents the ES start code (S703-NO), the data outputting unit 204 outputs ES start code location data which represents a location of the ES start code (S710).

S701 to S710 are repetitively performed until there is an instruction to finish the start code detecting process (S711-NO), and if there is an instruction to finish the start code detecting process (S711-YES), the start code detecting process according to the second embodiment of the present invention is finished.

Next, a first modification of the second embodiment of the present invention will be described. The first modification of the second embodiment of the present invention deals with an example that a buffer includes a plurality of buffering areas (first and second buffering areas).

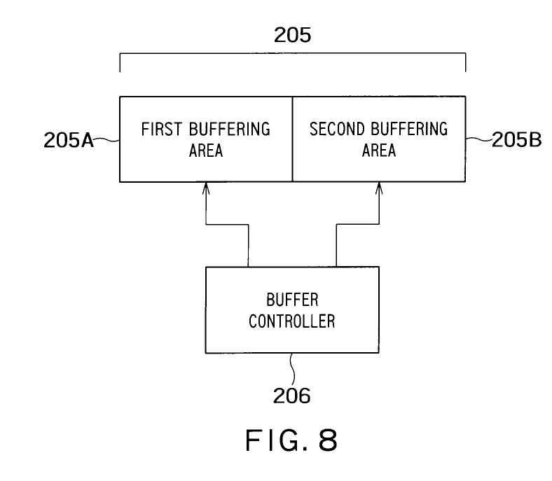

FIG. 8 is a schematic diagram illustrating a structure of a buffer 205 according to the first modification of the second embodiment of the present invention.

The buffer 205 according to the first modification of the second embodiment of the present invention includes a first buffering area 205A and a second buffering area 205B.

First, a buffer controller 206 writes PES data in the first buffering area 205A. After the first buffering area 205A cannot store PES data (that is, after a capacity of the first buffering area is fully occupied), the buffer controller 206 writes PES data in the second buffering area 205B. The buffer controller 206 alternately performs writing of PES data in the first buffering area 205A and writing of PES data in the second buffering area 205B. Also, the buffer controller 206 searches for data stored in one buffering area (for example, second buffering area 205B) while writing data in the other buffering area (for example, first buffering area 205A).

According to the second embodiment of the present invention, since PES data is written in the buffer 205, the number of memory access times can be reduced as compared with the first embodiment of the present invention.

According to the first modification of the second embodiment of the present invention, since PES data is alternately recorded in the first buffering area 205A and the second buffering area 205B, memory access can be avoided when PES data or PES header length data does not exist in the buffer 205, and thus the number of memory access times can be reduced as compared with the second embodiment of the present invention.

According to the first modification of the second embodiment of the present invention, since data stored in one buffering area is searched while data is written in the other buffering area, a processing time of the start code detecting apparatus 200 can be reduced as compared with the second embodiment of the present invention.

### Third Embodiment

Next, a third embodiment of the present invention will be described. The third embodiment of the present invention deals with an example that a zero flag is set to a register. The duplicated description with respect to the first and second embodiments of the present invention will not be repeated.

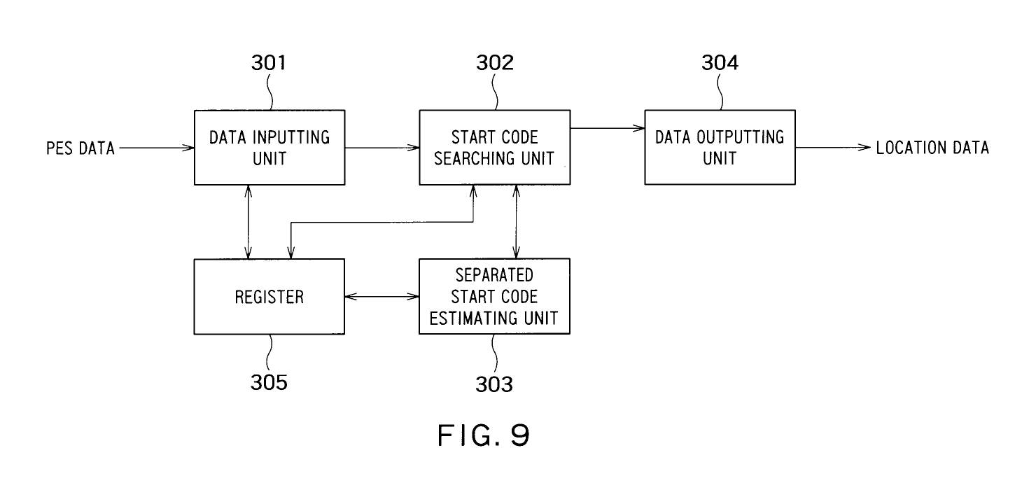

FIG. 9 is a block diagram illustrating a configuration of a start code detecting apparatus 300 according to the third embodiment of the present invention.

The start code detecting apparatus 300 includes a data inputting unit 301, a start code searching unit 302, a separated start code estimating unit 303, a data outputting unit 304, and a register 305.

The data inputting unit 301 reads PES data from the memory 110 and transmits the PES data to the start code searching unit 302.

The start code searching unit 302 searches for a code of a predetermined byte included in the PES data inputted from the data inputting unit 301. The start code searching unit 302 generates location data which represents a location of a PES start code or an ES start code based on the searching result and an estimation result of the separated start code estimating unit 303, and transmits the location data to the data outputting unit 304. The location data includes address information which represents a location of a start code and identification (ID) information which identifies the PES start code or the ES start code. The start code searching unit 302 sets a flag which represents a location that there is a possibility that the ES start code is separated to the register 305 based on the searching result.

The separated start code estimating unit 303 refers to a stream ID located next to a code of a predetermined byte searched by the start code searching unit 302, estimates whether there is a separated ES start code which is separated by the PES header or not based on the reference result, and transmits the estimation result to the start code searching unit 302.

The data outputting unit 304 outputs the location data received from the start code searching unit 302 to the data analyzing apparatus 120.

The register 305 stores a flag which represents a location that there is a possibility that the ES start code is separated and a read address of the memory 110 accessed by the data inputting unit 301 when data is read from the memory 110.

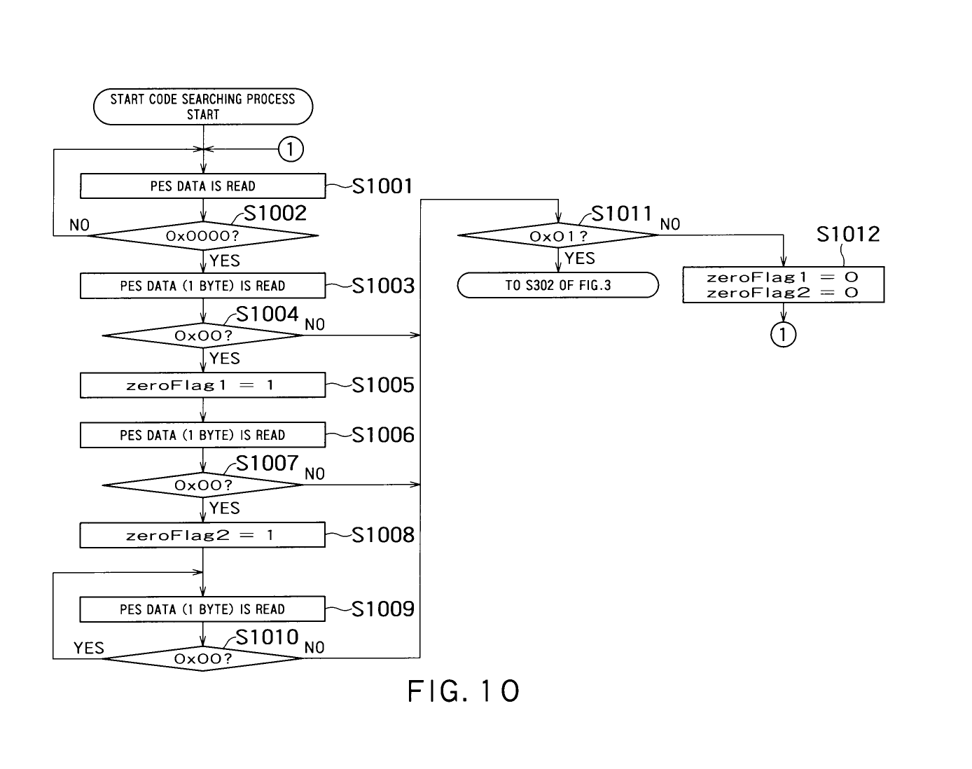

FIG. 10 is a flowchart illustrating a start code searching process according to the third embodiment of the present invention.

First, PES data stored in the memory 110 is read one byte by one byte (S1001). S1001 is repetitively performed until a predetermined code (for example, “0x0000”) is searched (S1002-NO).

If the PES data read in S1001 is a predetermined code (S1002-YES), PES data located next to the PES data read in S1001 is read one byte (S1003).

If the PES data read in S1003 is a predetermined code (for example, “0x00”) (S1004-YES), a flag (for example, “zeroFlag1”) which represents that there is a possibility that the ES start code (for example, “0x000001”) is separated into “00” and “0001” is set to the register 305 (S1005). For example, as shown in FIG. 11A, when the ES start code can be separated into a code (“0x00”) of one byte before the PES header and a code (“0x0001”) of two bytes after the PES header by the PES header, a value of “1” is set to the “zeroFlag1”.

Next, PES data located next to the PES data read in S1003 is read one byte (S1006).

If the PES data read in S1006 is a predetermined code (for example, “0x00”) (S1007-YES), a flag (for example, “zeroFlag2”) which represents that there is a possibility that the ES start code (for example, “0x000001”) is separated into “0000” and “01” is set to the register 305 (S1008). For example, as shown in FIG. 11B, when the ES start code can be separated into a code (“0x0000”) of two bytes before the PES header and a code (“0x00”) of one byte after the PES header by the PES header, a value of “1” is set to the “zeroFlag2”.

Next, PES data located next to the PES data read in S1006 is read one byte (S1009). S1009 is repetitively performed until any other code than a predetermined code (for example, “0x00”) is searched (S1010-YES).

On the other hand, if the PES data read in S1003 or S1006 is not a predetermined code (for example, “0x00” and “0x01”) (S1004-NO or S1007-NO and S1011-NO), the register 305 is reset (S1012). For example, when values of “0” are set to the “zeroFlag1” and “zeroFlag2”, the register 305 is reset.

Also, even if the PES data read in S1009 is not a predetermined code (for example, “0x00” and “0x01”) (S1010-NO, S1011-NO), the register 305 is reset (S1012).

On the other hand, if the PES data read in S1003 or S1006 is a predetermined code (for example, “0x01”) (S1004-NO or S1007-NO and S1011-YES), the procedure proceeds to S302 of FIG. 3.

Also, even if the PES data read in S1009 is a predetermined code (for example, “0x01”) (S1010-NO, S1011-YES), the procedure proceeds to S302 of FIG. 3.

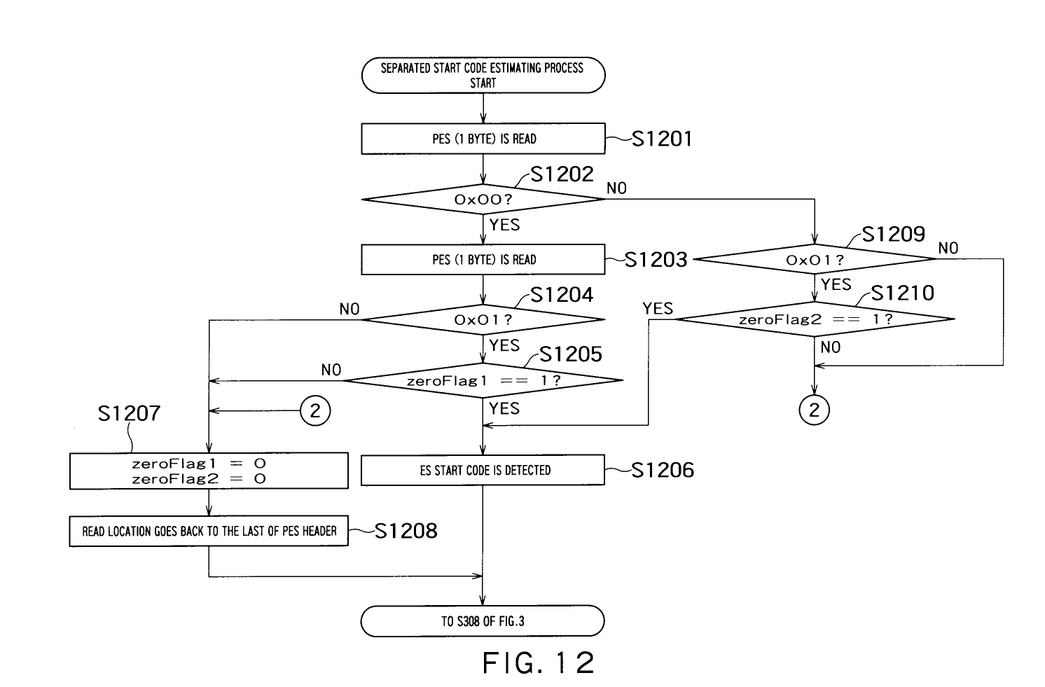

FIG. 12 is a flowchart illustrating a separated start code estimating process according to the third embodiment of the present invention.

First, PES data located next to a PES header is read one byte (S1201).

If the PES data read in S1201 is a predetermined code (for example, “0x00”) (S1202-YES), PES data located next to the PES data read in S1201 is read one byte (S1203).

In case where the PES data read in S1203 is a predetermined code (for example, “0x01”) (S1204-YES), if “zeroFlag1” is set to the register 305 (S1205-YES), for example “zeroFlag1 is a value of “1”, a separated ES start code is detected (S1206), and the procedure proceeds to S308 of FIG. 3.

In case where the PES data read in S1203 is not a predetermined code (for example, “0x01”) (S1204-NO) or in case where the PES data read in S1203 is a predetermined code (for example, “0x01”) (S1204-YES), if “zeroFlag1” is not set to the register 305 (S1205-NO), for example “zeroFlag1” is a value of “0”, the register 305 is reset (S1207). For example, when values of “0” are set to the “zeroFlag1” and “zeroFlag2”, the register 305 is reset.

Next, a read location goes back to the last of the PES header (S1208), and the procedure proceeds to S308 of FIG. 3.

On the other hand, if the PES data read in S1201 is not a predetermined code (for example, “0x00”) (S1202-NO) but a predetermined code (for example, “0x01”) (S1209-YES) and “zeroFlag2” is set to the register 305 (S1210-YES), for example “zeroFlag2” is a value of “1”, the procedure proceeds to S1206.

In case where the PES data read in S1201 is neither a predetermined code (for example, “0x00”) (S1202-NO) nor a predetermined code (for example, “0x01”) (S1209-NO) or in case where the PES data read in S1201 is not a predetermined code (for example, “0x00”) (S1202-NO) but a predetermined code (for example, “0x01”) (S1209-YES), if “zeroFlag2” is not set to the register 305 (S1210-NO), for example “zeroFlag2” is a value of “0”, the procedure proceeds to S1207.

Alternatively, in the third embodiment of the present invention, similar to the second embodiment of the present invention, the start code detecting apparatus 300 can further include a buffer and a buffer controller.

According to the third embodiment of the present invention, since a flag which represents a location which represents that there is a possibility that the ES start code is separated is set to the register 305, whether the ES start code is separated or not can be securely detected, and the processing speed of the start code detecting apparatus 300 can be improved as compared with the first and second embodiments of the present invention.

The start code detecting apparatuses 100 to 300 described above may be at least partially configured by hardware or software. If configured by software, a program which realizes at least some of functions of the start code detecting apparatuses 100 to 300 may be recorded on a recording medium such as a flexible disc or a CD-ROM and may be executed by a computer. The recording medium is not limited to a removable one such as a magnetic disc or an optical disc, but can be applied to a fixed recording medium such as a hard disc device or a memory.

A program, which realizes at least some of functions of the start code detecting apparatuses 100 to 300, may be distributed through a communication circuit (including a wireless communication) such as the Internet. Also, the program may distributed by means of a fixed and wireless circuit such as the Internet or a recording medium in an encrypted state or a modulated or compressed state.

What is claimed is:

1. A start code detecting apparatus, comprising:
a data inputting unit which inputs packetized elementary stream (PES) data;
a start code searching unit which searches for a code of a predetermined byte included in the PES data inputted by the data inputting unit;
a separated start code estimating unit which refers to a stream identification (ID) located next to a code of a predetermined byte searched by the start code searching unit and estimates whether there is a separated ES (Elementary Stream) start code or not based on the reference result; and
a data outputting unit which outputs predetermined data,
wherein the start code searching unit generates location data which represents a location of the PES start code or the ES start code based on the searching result and the estimation result of the separated start code estimating unit, and
the data outputting unit outputs the location data generated by the start code searching unit.

2. The start code detecting apparatus of claim 1, further comprising, a buffer which stores the PES data,
wherein the data inputting unit writes the PES data in the buffer, and
the start code searching unit searches for a code of a predetermined byte included in the PES data stored in the buffer.

3. The start code detecting apparatus of claim 2, wherein when the PES start code is detected, if PES header length data exists in PES data stored in the buffer, the start code searching unit skips the PES data based on the PES header length data.

4. The start code detecting apparatus of claim 3, wherein the start code searching unit is connected to a memory which stores PES header length data, when the PES start code is detected, if PES header length data does not exist in PES data stored in the buffer, the start code searching unit skips the PES data based on the PES header length data stored in the memory.

5. The start code detecting apparatus of claim 2, further comprising, a buffer controller which controls writing and reading of data stored in the buffer,
wherein the buffer includes first and second buffering areas, and
the buffer controller writes the PES data in the first buffering area when the first buffering area is able to store the PES data, and writes the PES data in the second buffering area after the first buffering area is not able to store the PES data.

6. The start code detecting apparatus of claim 1, further comprising, a flag register which stores information which represents a location of the separated ES start code,
wherein when there is the separated ES start code, the separated start code estimating unit sets a flag which represents a location that the ES start code is separated to the flag register.

7. The start code detecting apparatus of claim 1, wherein the start code searching unit generates location data which represents a location of the PES or ES header.

8. The start code detecting apparatus of claim 7, wherein the start code searching unit generates location data which includes address information of the PES or the ES header and ID information which identifies the PES or the ES.

9. A start code detecting method, comprising:
inputting packetized elementary stream (PES) data;
searching for a code of a predetermined byte included in the PES data;
refering to a stream identification (ID) located next to a code of the predetermined byte,
estimating whether there is a separated ES (Elementary Stream) start code based on the reference result;
generating location data which represents a location of the PES start code or the ES start code; and
outputting the location data.

10. The start code detecting method of claim 9, wherein the inputting includes writing the PES data in a buffer which stores the PES data, and
the searching includes searching for a code of a predetermined byte included in the PES data stored in the buffer.

11. The start code detecting method of claim 10, wherein when the PES start code is detected, if PES header length data exists in PES data stored in the buffer, the searching includes skipping the PES data based on the PES header length data.

12. The start code detecting method of claim 11, wherein when the PES start code is detected, if PES header length data does not exist in PES data stored in the buffer, the searching includes skipping the PES data based on the PES header length data stored in a memory which stores PES header length data.

13. The start code detecting method of claim 10, further comprising,
writing the PES data in the first buffering area of the buffer when the first buffering area is able to store the PES data, and writing the PES data in the second buffering area of the buffer after the first buffering area is not able to store the PES data.

14. The start code detecting method of claim 9, wherein when there is the separated ES start code, the estimating includes setting a flag which represents a location that the ES start code is separated to a flag register storing information which represents a location of the separated ES start code.

15. The start code detecting method of claim 9, wherein the searching includes generating location data which represents a location of the PES or ES header.

16. The start code detecting method of claim 15, wherein the searching includes generating location data which includes address information of the PES or the ES header and ID information which identifies the PES or the ES.

17. A computer readable medium storing start code detecting program, the program comprising:
a data inputting instruction which inputs packetized elementary stream (PES) data;
a start code searching instruction which searches for a code of a predetermined byte included in the PES data inputted by the data inputting instruction;
a separated start code estimating instruction which refers to a stream identification (ID) located next to a code of a predetermined byte searched by the start code searching instruction and estimates whether there is a separated ES start code based on the reference result; and
a data outputting instruction which outputs predetermined data,
wherein the start code searching instruction generates location data which represents a location of the PES start code or the ES start code based on the searching result and the estimation result of the separated start code estimating instruction, and
the data outputting instruction outputs the location data generated by the start code searching instruction.

18. The medium of claim 17, wherein the data inputting instruction writes the PES data in a buffer which stores the PES data, and
the start code searching instruction searches for a code of a predetermined byte included in the PES data stored in the buffer.

19. The computer readable medium of claim 18, wherein when the PES start code is detected, if PES header length data exists in PES data stored in the buffer, the start code searching instruction skips the PES data based on the PES header length data.

20. The computer readable medium of claim 19, when the PES start code is detected, if PES header length data does not exist in PES data stored in the buffer, the start code searching instruction skips the PES data based on the PES header length data stored in a memory which stores PES header length data.
